(19) United States
(12) Patent Application Publication
(10) Pub. No.: US 2021/0128374 A1
(43) Pub. Date: May 6, 2021

(54) ADAPTABLE VEHICLE SEAT BELT FOR A WHEELCHAIR

(71) Applicant: AMF-BRUNS GmbH & CO. KG, Apen (DE)

(72) Inventor: JOSE ESTEIREIRO, CAMBRIDGE (CA)

(21) Appl. No.: 17/084,123

(22) Filed: Oct. 29, 2020

Related U.S. Application Data
(60) Provisional application No. 62/929,262, filed on Nov. 1, 2019.

(51) Int. Cl. A61G 3/08; B60R 22/24

(52) U.S. Cl. CPC A61G 3/0808; B60R 2022/1806; B60R 22/24

(57) ABSTRACT

Provided in this disclosure is an adaptable vehicle seat belt for wheelchair that can be selectively modified to provide a pin connector mode and alternatively a three-point connector mode that provides safe restraint to non-compliant wheelchairs. The present adaptable wheelchair vehicle seat belt includes a height adjuster belt and a retractor belt that terminates with a female buckle. The height adjuster belt and the retractor belt both slideably engage a dual slot tongue. A pin connector tongue is adapted to freely slide along the retractor belt between the female buckle and the dual slot tongue. The pin connector tongue is adapted to selectively engage an extension belt, used in the three-point connector mode, or a pin connector mounted to the wheelchair in a pin connector mode. In the latter aspect, the dual slot tongue securely connects with the female buckle.

This application claims the benefit of U.S. Provisional Application No. 62/929,262, entitled ADAPTABLE VEHICLE SEAT BELT FOR A WHEELCHAIR, filed Nov. 1, 2019, which is fully incorporated herein by reference.

### I. BACKGROUND

The present teachings pertain to the field of seat belts for restraining a vehicle passenger in the event of a crash. In particular, the present teachings pertain to the field of seat belts for safely restraining a wheelchair vehicle passenger in the event of a crash.

Certain safety requirements are observed for transporting wheelchair passengers, such as in school buses and other public vehicles. Industry standards have evolved in recent years for safety restraints including seat belts for wheelchairs. The WC/18 standard a restraint system with both a pelvic belt and at least one shoulder belt, providing a three-point belt restraint system.

WC18 is a revised and updated version of SAE J2249, Wheelchair Tiedown and Occupant Restraint Systems for Use in Motor Vehicles. An update to this standard was published in December 2017 as part of the American National Standards Institute/Rehabilitation Engineering and Assistive Technology Society of North America (ANSI/RESNA) Wheelchair Standards/Volume 4: Wheelchairs and Transportation. For people with disabilities who are not able to safely transfer from their wheelchairs, including three- and four-wheeled scooters, when traveling in motor vehicles, the wheelchair must serve as the vehicle seat. This usually means that the belt-restraint system installed by the vehicle manufacturer (i.e., the OEM belt restraint) cannot be used to provide protection in a crash. In addition, the wheelchair must be effectively secured to the vehicle so that its mass does not add to restraint forces on its occupant and/or become a hazard to other vehicle occupants in a collision or sudden vehicle maneuver. Providing occupants seated in wheelchairs with adequate transportation safety and crash protection therefore requires the installation of equipment in vehicles to provide these travelers with the opportunity for effective wheelchair securement and occupant restraint during normal and emergency vehicle operation and crash situations.

The provisions of WC18 are based on the premise that WTORS manufacturers are generally not able to control the end use of their products and the vehicles in which they are installed. WC18 therefore requires crashworthiness evaluation of WTORS for general use in all types and sizes of motor vehicles by conducting a nominally worst-case 48 kph (30 mph) frontal sled-impact test using an 85 kg (185 lb) surrogate wheelchair and a midsize adult male anthropomorphic test device (ATD), or crash-test dummy, with a nominal mass of 78 kg (172 lb) to dynamically load the wheelchair tiedown and occupant restraint system, respectively. For vehicles with a gross vehicle weight (i.e., the fully loaded weight) greater than 5,000 kg (11,000 lb), it may be appropriate to qualify WTORS using a lower crash severity than is required by this standard because of the reduced likelihood of heavier vehicles being involved in severe impacts.

WC18 requires that every WTORS include a belt-type occupant-restraint system with both a pelvic belt and one or more shoulder belts since the evidence is clear that the combination of upper- and lower-torso belt restraints is the most effective method of reducing injuries and fatalities in a wide range of crash conditions, including frontal crashes, vehicle rollovers, and a large percentage of side impacts. In addition, belt restraints can be easily implemented in most forward-facing seating positions of passenger vehicles. However, this section of RESNA WC-4 allows for, and applies to, WTORS that use different approaches to wheelchair tiedown, including four-point, strap-type tiedowns, and docking securement devices.

WC19 is a revised and updated version of Section 19 of American National Standards Institute/Rehabilitation Engineering and Assistive Technology Society of North America (ANSI/RESNA) Wheelchair Standards/Volume 1, Wheelchairs Used as Seats in Motor Vehicles. The updated standard was published in December 2017 as part of the RESNA Wheelchair Standards/Volume 4: Wheelchairs and Transportation. The purpose of WC19 is to establish design and performance requirements, and associated test methods, for wheelchairs related to their use as seats in motor vehicles. This standard employs basic principles of occupant protection and accepted procedures for dynamic testing used in federal motor vehicle safety standards (FMVSS). In today's society where the number of people using wheelchairs is increasing, many wheelchair models will be used as seats in motor vehicles. Thus, wheelchair manufacturers are encouraged to acknowledge this use of wheelchairs and to proactively offer products that are compliant with WC19 whenever possible.

For purposes of WC19, a wheelchair is considered to be a complete personal mobility device comprised of a frame, a seating system, wheels, and casters that provides seated support and mobility for persons with physical disabilities. A wheelchair that complies with all the requirements of this standard is considered to provide a reasonable measure of safe and effective seating during vehicle ingress/egress, during normal transportation, and during a vehicle collision. WC19 specifies general design requirements, test procedures, and performance requirements for complete wheelchairs that can be considered to offer suitable and safe forward-facing seating for passengers traveling in transit, paratransit, school bus, over-the-road coaches, and personally licensed vehicles. The standard applies to the securement of wheelchairs by four-point strap-type tiedown systems that are occupied by child- and adult-sized passengers restrained by belt-type occupant restraints. The standard applies to a wide range of wheelchair types and styles, including manual wheelchairs, powerbase wheelchairs, three-wheeled scooters, tilt-in-space wheelchairs, and specialized mobile seating bases with removable seating inserts. It applies primarily to wheelchairs as purchased from the OEM manufacturer, but also has application to wheelchairs that are retrofitted for use as a motor-vehicle seat by the addition of after-market add-on components.

Some transport vehicles and wheelchairs are configured for a three-point connector system while others are configured for a pin connector. This can pose a problem for vehicles in transporting persons in wheelchairs that are not complaint with the standard utilized on a particular vehicle.

### II. SUMMARY

Provided in this disclosure is an adaptable vehicle seat belt for a wheelchair that can be selectively modified to be deployed in a pin connector mode and alternatively deployed in a three-point connector mode. The adaptable wheelchair vehicle seat belt of the present teachings includes an upper wall anchor point at a top end and a retractor at the opposite end, with a height adjuster belt and a retractor belt supported therebetween. The retractor belt terminates with a female buckle. The height adjuster belt and the retractor belt both slideably engage a dual slot tongue. A pin connector tongue is adapted to freely slide along the retractor belt between the female buckle and the dual slot tongue. The pin connector tongue is adapted to selectively engage an extension belt, used in the three-point connector mode, or a pin connector mounted to the wheelchair in a pin connector mode. In the latter mode, the dual slot tongue securely connects with the female buckle.

The adaptable vehicle seat belt for a wheelchair includes a height adjustment portion retained between an upper wall anchor point, mounted to an upper wall of a passenger vehicle, and a retractor, mounted to a floor of the passenger vehicle. A height adjuster belt of the height adjustment portion is connected to the upper wall anchor point. A retractor belt of the height adjustment portion variably extends and retracts from the retractor. The retractor belt has an end that terminates with a first buckle for optional secure engagement with a floor buckle secured to the floor of the vehicle when deployed in a three-point connector mode. A dual slot tongue includes a first slot for slideably engaging the height adjuster belt, a second slot for slideably engaging the retractor belt, and a first clip end for optional secure engagement with the first buckle when deployed in a pin connector mode. A pin connector tongue includes a third slot for slideably engaging the retractor belt, such that the pin connector tongue is adapted to freely slide along the retractor belt between the first buckle and the dual slot tongue. The pin connector tongue includes a second clip end for optional secure engagement with a second buckle of a belt extension connected to the floor of the vehicle when deployed in the three-point connector mode, and a keyhole for optional secure engagement with a pin connector mounted on the wheelchair when deployed in the pin connector mode.

The length of the height adjuster belt is adjustable with a first adjustable buckle, to establish a suitable height for the retractor belt to function as a shoulder belt for a wheelchair occupant. The keyhole includes a triangular portion that terminates with a round end, wherein the triangular portion is sized to admit and receive the pin connector such that the pin connector is slid into secure engagement with the round end. The retractor includes a reel that feeds out a desired length of the retractor belt. The belt extension includes a first belt having an end that engages the second buckle and a length varied by selectively sliding the first belt through a second adjustable buckle. The second adjustable buckle further engages a second belt having a third buckle that engages a second floor buckle secured to the floor of the vehicle.

In another aspect of the present teaching, a shoulder belt adapter bracket can be provided for engaging different types of seat belts in the same vehicle. The shoulder belt bracket includes a mounting portion having a mounting structure for securing the bracket to a vehicle wall, a first engaging portion having an aperture for receiving a male connecting element of a first type of seat belt for connecting to the first type of seat belt in a first operative state, and a second engaging portion having a male end received for engagement with a female buckle of a second type of seat belt for connecting to the second type of seat belt in a second operative state. In this aspect, the mounting portion adjoins the first engaging portion which adjoins the second engaging portion along a central axis. The mounting portion, the first engaging portion and the second engaging portion are mirror symmetrical about the central axis.

In another aspect of the present teaching, the mounting portion is a generally round end portion and the mounting structure comprises a hole for receiving a securing bolt for mounting to a vehicle wall. The first engaging portion is a tapered portion formed to include a keyhole aperture for receiving and engaging a pin connector of the first type of seat belt in the first operative state. The second engaging portion is a generally square male clip end received for secure engagement within the female buckle of the second type of seat belt. The first type of seat belt is a conventional seat belt while the second type of seat belt is a WC/19 lap belt. The clip end includes an aperture that is configured to engage a suitable mating structure inside the female buckle in order to securely retain the clip end within the female buckle until selectively released by a user.

The keyhole aperture includes a triangular portion that terminates with a round end. The triangular portion is sized to admit and receive the pin connector such that the pin connector is slid into secure engagement with the round end. The pin connector includes a pin having a head and a shank such that the round end has a diameter comparable to the so that the shank is received in the round end. The diameter of the round end is smaller than the head so that the head securely retains the shank in engagement with the keyhole aperture.

According to an aspect of the present teaching, the present safety belt system provides an adaptable wheelchair safety belt design that complies with multiple existing standards.

According to another aspect of the present teaching, the present safety belt system provides an adaptable safety belt design that provides safe restraint for multiple types of wheelchairs.

According to yet another aspect of the present teaching, the present safety belt system provides a single component that can be readily adapted to multiple types of wheelchairs.

According to still another aspect of the present teaching, the present safety belt system provides an economical solution without requiring special reconfiguration.

Still other benefits and advantages of the present subject matter will become apparent to those skilled in the art to which it pertains upon a reading and understanding of the following detailed specification.

### III. BRIEF DESCRIPTION OF THE DRAWINGS

The disclosed adaptable wheelchair vehicle seat belt may take physical form in certain parts and arrangement of parts, aspects of which will be described in detail in this specification and illustrated in the accompanying drawings which form a part hereof and wherein:

FIG. 1 is a plan view of the adaptable wheelchair vehicle seat belt in accordance with the present teaching;

FIGS. 2A and 2B are respective oblique views of the dual slot tongue and the pin connector tongue in accordance with the present teaching;

FIG. 3 is a partially exploded perspective view of the adaptable wheelchair vehicle seat belt in accordance with the present teaching;

FIG. 4 is a partially exploded perspective view of the adaptable wheelchair vehicle seat belt shown in the three-point connection mode in accordance with the present teaching;

FIG. 5 is a partially exploded perspective view of the adaptable wheelchair vehicle seat belt shown in the pin connector mode in accordance with the present teaching;

FIG. 6 is a rear view of the adaptable wheelchair vehicle seat belt shown in the pin connector mode in accordance with the present teaching;

FIG. 7 is a perspective view illustrating details of a WC/19 compliant lap belt in accordance with the modes shown in FIGS. 5 and 6;

FIGS. 8A, 8B, 8C, and 8D are respective front, side-sectional, side, and oblique views of the double bended tongue in accordance with an alternative aspect of the present teaching;

FIGS. 9A, 9B, and 9C are respective oblique, top, and side views of the shoulder belt adapter bracket in accordance with a further alternative embodiment of the present teaching;

FIGS. 10A and 10B are top views showing operative connection of the clip end of the shoulder belt adapter bracket engaging with a buckle in accordance with the alternative embodiment of FIGS. 9A, 9B, and 9C;

FIG. 11 is a perspective view showing operative connection of the clip end of the shoulder belt adapter bracket, attached to a vehicle wall, engaging with a buckle and belt in accordance with the alternative embodiment of FIGS. 9A, 9B, and 9C;

FIGS. 12A and 12B are oblique views showing operative connection of the keyhole aperture of the shoulder belt adapter bracket engaging with a pin connector of a WC/19 lap belt in accordance with the alternative embodiment of FIGS. 9A, 9B, and 9C; and

FIG. 13 is a perspective view showing operative connection of the keyhole aperture of the shoulder belt adapter bracket, attached to a vehicle wall, engaging with a pin connector of a WC/19 lap belt in accordance with the alternative embodiment of FIGS. 9A, 9B, and 9C.

### IV. DETAILED DESCRIPTION

Referring now to the drawings wherein the showings are for purposes of illustrating aspects of the article only and not for purposes of limiting the same, and wherein like reference numerals are understood to refer to like components:

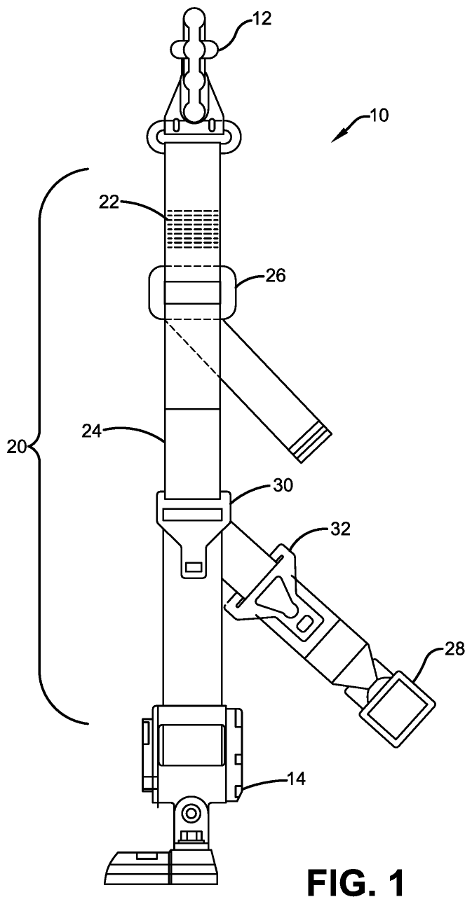

FIG. 1 is a plan view showing the components and general configuration of the of the adaptable wheelchair vehicle seat belt 10. An upper wall anchor point 12 is at a top end of the belt 10 while a retractor 14 is at the opposite end, at the bottom of the belt 10. A height adjustment portion 20 is retained between the upper wall anchor point 12 and the retractor 14. The height adjustment portion 20 is comprised of a height adjuster belt 22 and a retractor belt 24. The height adjuster belt 22 is connected to the upper wall anchor point 12 and the length of the height adjuster belt 22 is adjustable with a first adjustable buckle 26. The retractor belt 24 is variably extending and retracting from the retractor 14. The retractor belt 24 has an end that terminates with a first female buckle 28 for optional secure engagement with a first floor buckle secured to the floor of the vehicle (when deployed in a three-point connector mode, as explained in greater detail hereinbelow). The height adjuster belt 22 and the retractor belt 24 both slideably engage a dual slot tongue 30. A pin connector tongue 32 is adapted to freely slide along the retractor belt 24 between the first female buckle 28 and the dual slot tongue 30.

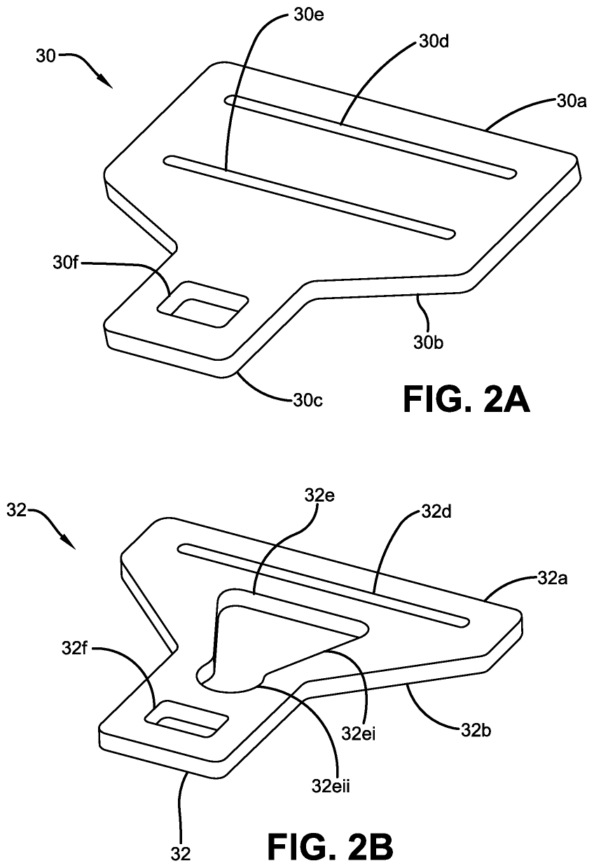

As particularly shown in FIG. 2A, the dual slot tongue 30 has a generally rectangular portion 30a formed with a tapered portion 30b that terminates with a generally square clip end 30c. The rectangular portion 30a includes a first slot 30d for slideably engaging the height adjuster belt 22 and a second slot 30e for slideably engaging the retractor belt 24. The clip end 30c (i.e., a first clip end) is a male clip that is received for secure engagement within the first female buckle 28 (when deployed in the pin connector mode, as described in detail hereinbelow). The clip end 30c includes an aperture 30f that engages a mating structure inside the first female buckle 28 in order to securely retain the clip end 30c within the first female buckle 28 until selectively released.

As particularly shown in FIG. 2B, the pin connector tongue 32 has a generally rectangular portion 32a formed with a tapered portion 32b that terminates with a generally square clip end 32c (i.e., a second clip end). The rectangular portion 32a includes a slot 32d for slideably engaging retractor belt 24. The clip end 32c is a male clip that is received for secure engagement within a second female buckle 44 of the belt extension 40 that is connected to the floor of the vehicle when deployed in the three-point connector mode (as described in detail hereinbelow). The tapered portion 32b and the clip end 32c are formed to include a keyhole 32e that has an enlarged, generally triangular portion 32ei that terminates with a round end 32eii at a lower corner of the triangular portion 32ei.

In a pin connector mode of the adaptable wheelchair vehicle seat belt 10, the keyhole 32e is configured for optional secure engagement with a pin connector 62 mounted on the wheelchair 52 when deployed in the pin connector mode (described in detail hereinbelow). The enlarged, triangular portion is sized to easily admit and receive the pin connector 62, and then the pin connector 62 is slid downward for secure engagement with the round end. The clip end 32c also includes an aperture 32f that engages a mating structure inside the second female buckle 44 in order to securely retain the clip end 32c within the second female buckle 44 until selectively released in a three-point connection mode of the adaptable wheelchair vehicle seat belt 10, as will be explained in detail hereinbelow.

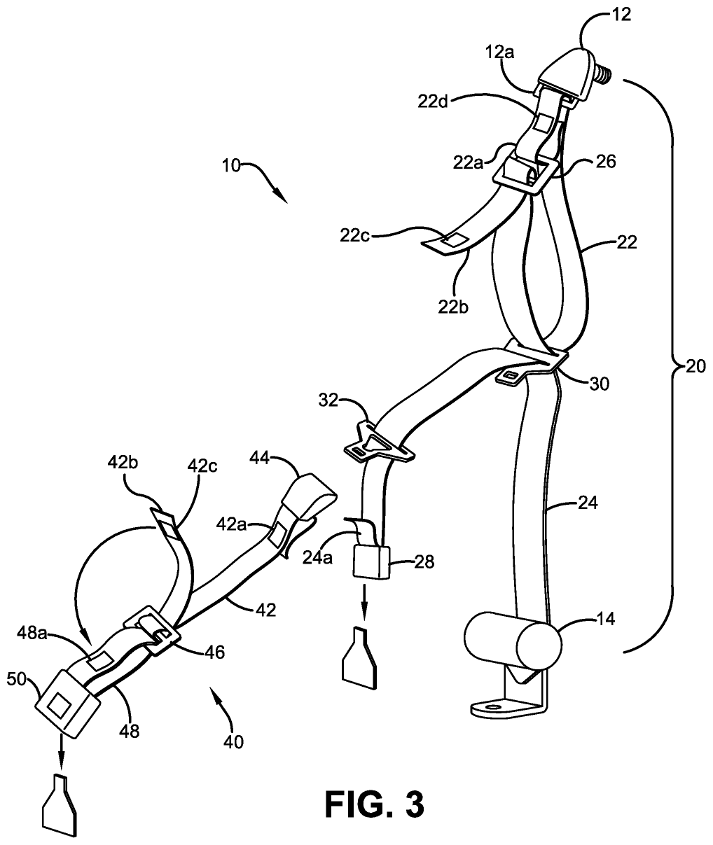

In particular reference now to the partially exploded perspective view of FIG. 3, the upper wall anchor point 12 is mounted to the upper wall of a passenger vehicle, above the level of a window, and is securely mounted to provide the necessary restraint of the wheelchair 52 and occupant in the event of a crash. The upper wall anchor point 12 can be mounted to a track which is in turn mounted to the vehicle upper wall. Alternatively, the upper wall anchor point 12 can be bolted directly into a vehicle structural support member for secure mounting, as depicted in FIG. 3.

The upper wall anchor point 12 supports the height adjuster belt 22. As shown in FIG. 3, the upper wall anchor point 12 can include a buckle portion 12a around which a stitched loop 22a is formed, which engages a suitable portion of the first adjustable buckle 26. An end 22b of the height adjuster belt 22 is threaded through the first slot 30d of the dual slot tongue 30 and then through the first adjustable buckle 26. A desired length of the end 22b is drawn through the first adjustable buckle 26 in order to take up the necessary slack to thereby set an overall length for the height adjuster belt 22, in order to set the dual slot tongue 30 at a desired height for the intended use. The end 22b can be retained from free movement by a first hook-and-loop fastener section 22c attached thereto which is securely engaged to a first mating hook-and-loop fastener section 22d attached to the stitched loop 22a.

With continued reference to FIG. 3, the retractor 14 is securely mounted to the floor of the vehicle. The retractor 14 is a reel device that feeds out a desired length of the retractor belt 24 and provides the anchor function to the opposite end from the upper wall anchor point 12. The retractor belt 24 is slideably inserted and retained through the second slot 30e of the dual slot tongue 30 and then slideably inserted and retained through the slot 32d of the pin connector tongue 32. And end of the retractor belt 24 is formed as a first stitched loop 24a retained at the first female buckle 28.

With continued reference to FIG. 3, a belt extension 40 is used for the three-point connection mode. The belt extension 40 includes a first belt 42 having an end that engages a second female buckle 44 and terminates in a second stitched loop 42a. The first belt 42 has an end 42b that slideably engages a second adjustable buckle 46. A second belt 48 engages with a third female buckle 50 and the second adjustable buckle 46 and is stitched for securely retaining the second belt 48.

The length of the first belt 42 is varied by selectively sliding the end 42b of the first belt 42b through the second adjustable buckle 46 until the desired length is obtained for securement of the wheelchair in the three-point connection mode, as will be described in detail hereinbelow. The end 42b can be retained from free movement by a second hook-and-loop fastener section 42c attached thereto which is securely engaged to a second mating hook-and-loop fastener section 48a attached to the second belt 48.

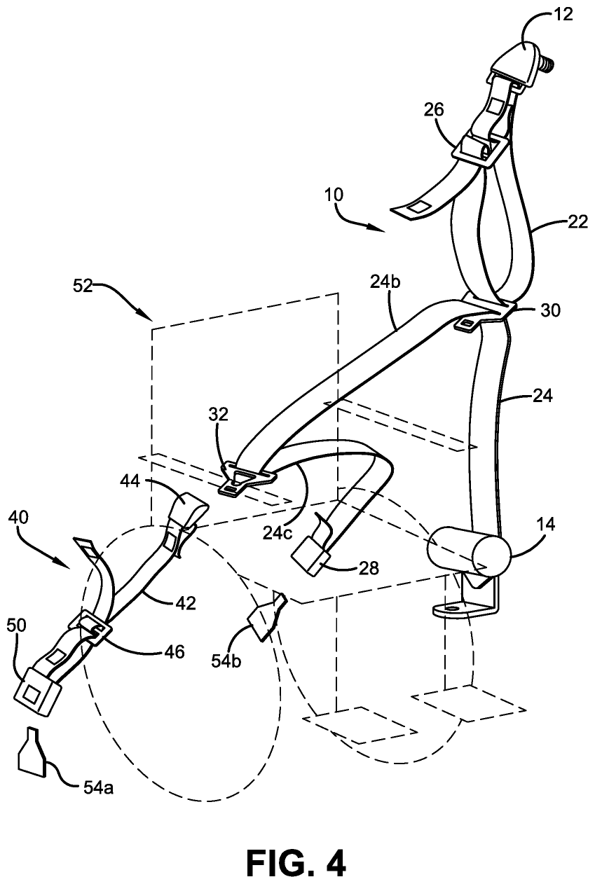

In particular reference now to the partially exploded perspective view of FIG. 4, the adaptable wheelchair vehicle seat belt 10 is shown in the three-point connection mode for engaging a wheelchair 52 (shown in phantom). The height adjuster belt 22 is adjusted by sliding the length using the first adjustable buckle 26 as described hereinabove. The desired height is selected so that the dual slot tongue 30 is at a suitable height for the retractor belt 24 to function as a shoulder belt 24b for the wheelchair occupant.

A third female buckle 50 of the belt extension 40 is connected to a first male floor buckle portion 54a secured to the floor of the vehicle behind the wheelchair 52 so that the belt extension 40 is located between the wheelchair 52 and its wheel. The length of the belt extension 40 is adjusted by varying the length of the first belt 42 by sliding through the second adjustable buckle 46, so that the second female buckle 44 is set at the desired location by the hip of the wheelchair occupant. The retractor belt 24 is extended so that the clip end 32c of the pin connector tongue 32 engages with the second female buckle 44.

The retractor belt 24 is further extended so that the first female buckle 28 engages with a second male floor buckle portion 54b secured to the floor of the vehicle on the opposite side of the wheelchair 52 from the first male buckle portion 54a, alongside and behind the wheelchair 52. In this manner, the portion of the retractor belt 24 between the pin connector tongue 32 and the first female buckle 28 is between the wheelchair 52 and its opposite wheel so that the portion of the retractor belt 24 functions as a lap belt 24c for the wheelchair occupant. Similarly, the portion of the retractor belt 24 between the pin connector tongue 32 and the dual slot connector 30 functions as a shoulder belt 24b for the wheelchair occupant, thereby providing the three-point connection.

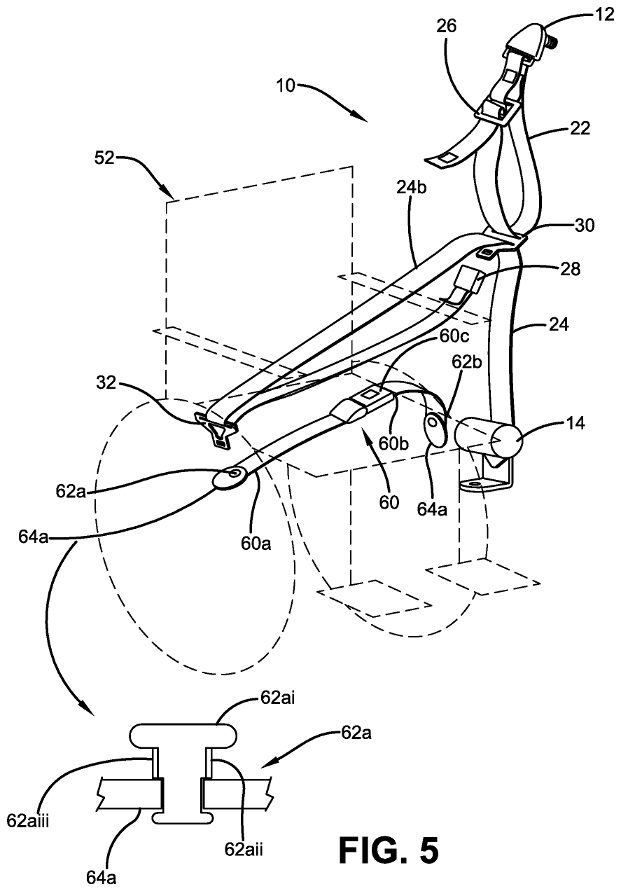

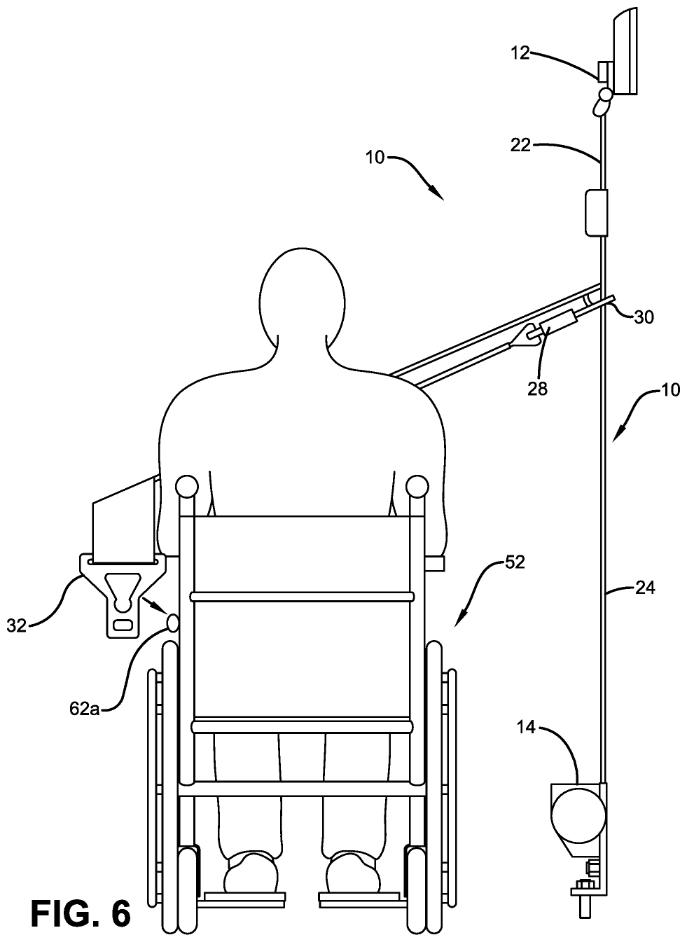

In particular reference now to the partially exploded view of FIG. 5 and the rear view of FIG. 6, the adaptable wheelchair vehicle seat belt 10 is shown in the pin connector mode for engaging a wheelchair 52 (shown in phantom). The height adjuster belt 22 is adjusted by sliding the length using the first adjustable buckle 26 as described hereinabove. The desired height is selected so that the dual slot tongue 30 is at a suitable height for the retractor belt 24 to function as a shoulder belt 24b for the wheelchair occupant.

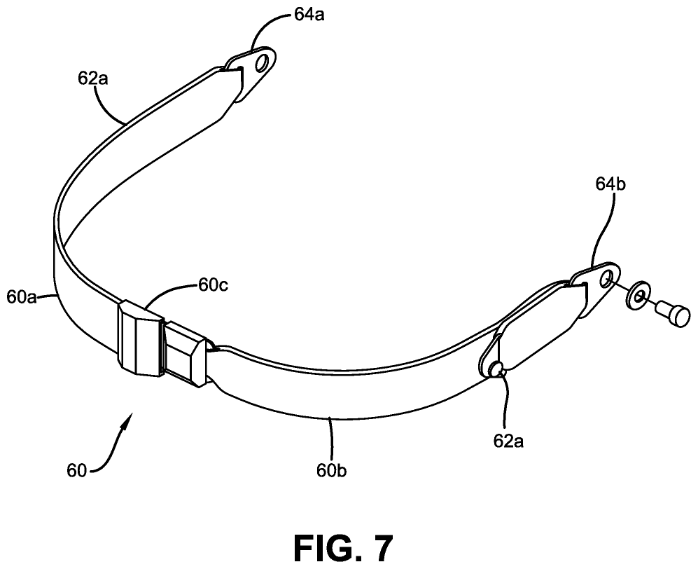

The belt extension 40 is removed for this mode. A wheelchair WC/19 lap belt 60 is installed on the wheelchair 52. As shown in FIG. 5 and particularly in FIG. 7, the wheelchair WC/19 lap belt 60 has two ends 60a, 60b which are joined in the middle with a buckle 60c over the lap of the wheelchair occupant. The two ends 60a, 60b are respectively secured to opposite sides of the wheelchair 52 using metal anchor plates 64a, 64b which are secured to the wheelchair 52 with respective screw and washer assemblies. The metal anchor plates 64a, 64b each include respective “mushroom head” style pin connectors 62a, 62b, a cross-sectional view of which is shown in the callout to FIG. 5. The exemplary pin connector 62a includes an enlarged head 62ai and a tapered shank 62aii, with a polymer sleeve 62aiii, and permanently fixed to the respective metal anchor plate 64a in accordance with the WC/19 standard. It is to be understood and appreciated that the other pin connector 62b is identical in construction.

The retractor belt 24 is extended so that the keyhole 32e of the pin connector tongue 32 engages with the pin connector 62a on the opposite side of the wheelchair 52 from the adaptable wheelchair vehicle seat belt 10. The enlarged head 62ai of the pin connector 62a is received into the enlarged, triangular portion 32ei of the keyhole 32e and the tapered shank 62aii slides into the round end 32eii of the pin connector tongue 32, where the round end 32eii has a diameter that mates with the diameter of the polymer sleeve 62aiii of the tapered shank 62aii. In this manner, the pin connector tongue 32 securely engages the enlarged head 62ai of the pin connector 62a and thereby retains the wheelchair 52. The retractor belt 24 is further extended so that the first female buckle 28 engages with the clip end 30c of the dual slot tongue 30. In this manner, the retractor belt 24 functions as a shoulder belt 24b for the wheelchair occupant. The wheelchair WC/19 lap belt 60 is directly secured to the wheelchair 52 and thereby provides effective restraint.

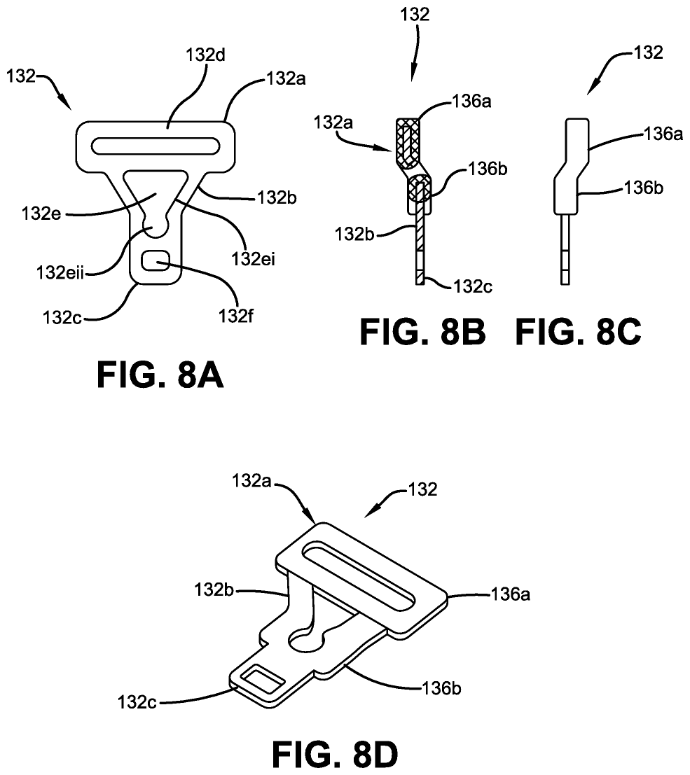

With reference to FIGS. 8A, 8B, 8C, and 8D, a double bended tongue 132 according to an alternative embodiment. The double bended tongue 132 has a generally rectangular portion 132a formed with a tapered portion 132b that terminates with a generally square clip end 132c (i.e., a second clip end). The rectangular portion 132a includes a slot 132d for slideably engaging the retractor belt 24. The clip end 132c is a male clip that is received for secure engagement within a second female buckle 44 of the belt extension 40 that is connected to the floor of the vehicle when deployed in the three-point connector mode (as described in detail hereinabove). The tapered portion 132b and the clip end 132c are formed to include a keyhole 132e that has an enlarged, generally triangular portion 132ei that terminates with a round end 132eii at a lower corner of the triangular portion 132ei.

With continued reference to FIGS. 8A, 8B, 8C, and 8D, in a pin connector mode of the adaptable wheelchair vehicle seat belt 10, the keyhole 132e is configured for optional secure engagement with a pin connector 62 mounted on the wheelchair 52 when deployed in the pin connector mode (described in detail hereinabove). The enlarged, triangular portion is sized to easily admit and receive the pin connector 62, and then the pin connector 62 is slid downward for secure engagement with the round end. The clip end 132c also includes an aperture 132f that engages a mating structure inside the second female buckle 44 in order to securely retain the clip end 132c within the second female buckle 44 until selectively released in a three-point connection mode of the adaptable wheelchair vehicle seat belt 10, as explained in detail hereinabove.

With specific reference to FIGS. 8B, 8C, and 8D, the double bended tongue 132 includes a bent portion 136 between the rectangular portion 132a and the tapered portion 132b. In this manner, the rectangular portion 132a and the tapered portion 132b reside in two different parallel planes. In this aspect, the rectangular portion 132a and the tapered portion 132b each include respective first and second coatings 136a, 136b in which a plastic material is coated onto at least a specific area of each of the respective portions 132a, 132b in order to reduce friction and protect the surfaces.

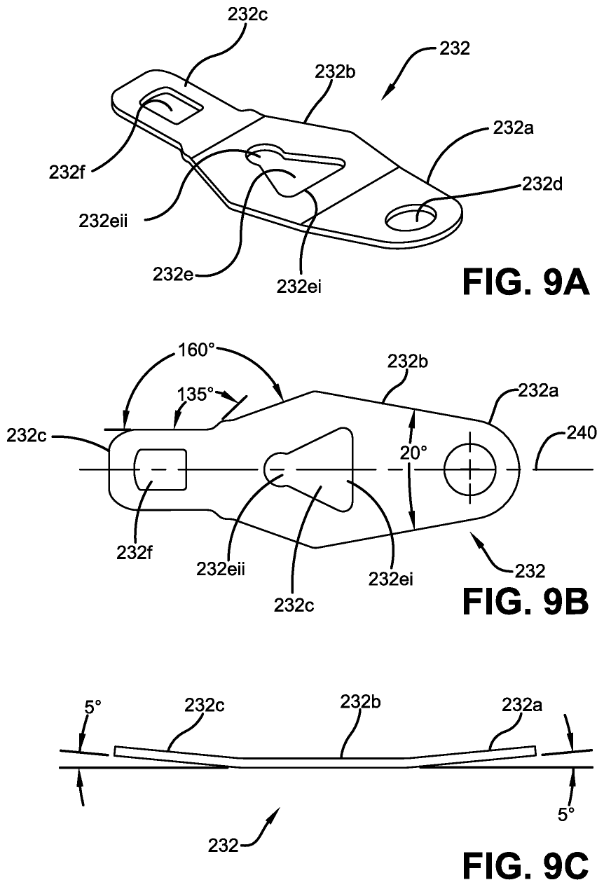

With reference to FIGS. 9A, 9B, and 9C, a shoulder belt adapter bracket 232 is contemplated in accordance with a further alternative embodiment. The shoulder belt adapter bracket 232 has a generally round end portion 232a formed with a tapered portion 232b having two tapered sides to form a generally hexagonal shape. The tapered portion 232b terminates with a generally square clip end 232c (i.e., a second clip end). The round end portion 232a includes a hole 232d for mounting to a vehicle wall (as will be explained in detail hereinbelow). The clip end 232c is a male clip that is received for secure engagement within a female buckle 244 of a seat belt. The tapered portion 232b is formed to include a keyhole 232e that has an enlarged, generally triangular portion 232ei that terminates with a round end 232eii at a lower corner of the triangular portion 132ei, proximate to the clip end 232c. The clip end 232c also includes an aperture 232f that is configured to engage a suitable mating structure inside a female buckle 244 in order to securely retain the clip end 232c within the female buckle 244 until selectively released by a user.

Exemplary proportions of the shoulder belt adapter bracket 232 are depicted in FIGS. 9A, 9B, and 9C. FIG. 9B shows a central axis 240 about which two sides of the shoulder belt adapter bracket 232 are mirror symmetrical. The round end portion 232a flares outward at an angle of 20 degrees (10 degrees on each side of the axis 240) so as to meet the slanting sides of the tapered portion 232b. The other slanting sides of the tapered portion 232b are formed at an obtuse angle of 160 degrees to the axis 240, but a region where the tapered portion 232b meets the clip end 232c is formed at a shallower angle of 135 degrees to the axis 240. As seen in FIG. 9C, the round end portion 232a and the clip end 232c are each formed in planes that are respectively inclined to the plane of the tapered portion 232b. In this manner, the portions of the shoulder belt adapter bracket 232 are formed so as to enable effective belt engagement, as described in detail hereinbelow. The round end portion 232a and the clip end 232c can be angled at 5 degrees in relation to the tapered portion 232b. It is to be understood that the round end portion 232a can be substantially planar with the tapered portion 232b, and can an angle anywhere between −45 degrees to 45 degrees with respect to the tapered portion 232b, inclusive of all angles within that range. It is to be understood that the clip end 232c can be substantially planar with the tapered portion 232b, and can an angle anywhere between −45 degrees to 45 degrees with respect to the tapered portion 232b, inclusive of all angles within that range. The round end portion 232a and clip end 232c do not need to have the same angle.

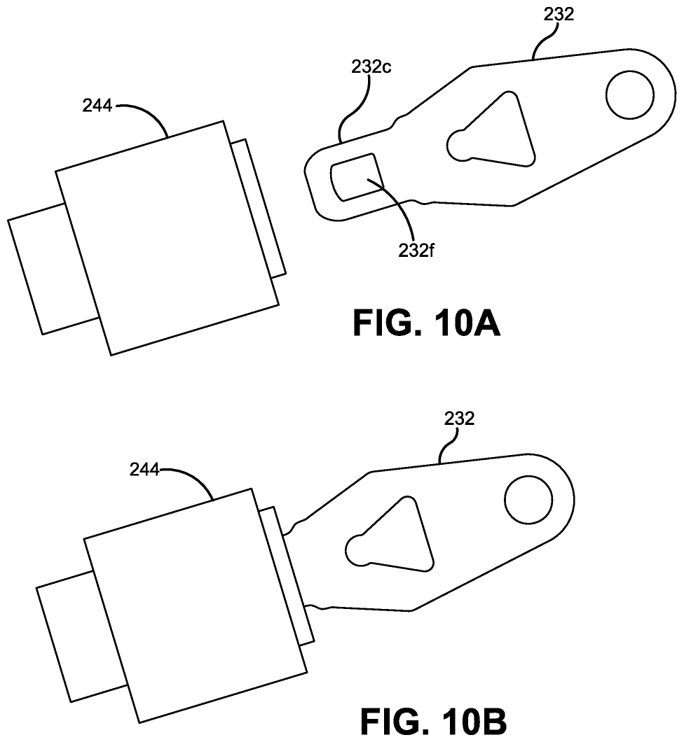

As shown in FIGS. 10A and 10B, the shoulder belt adapter bracket 232 is implemented in a first operative state to engage a female belt buckle 244 of a seat belt. The clip end 232c of the shoulder belt adapter bracket 232 is received into the female buckle 244 of a seat belt. The aperture 232f of the clip end 232c is configured to engage a suitable mating structure inside the female buckle 244 in order to securely retain the clip end 232c within the female buckle 244 until selectively released by the user.

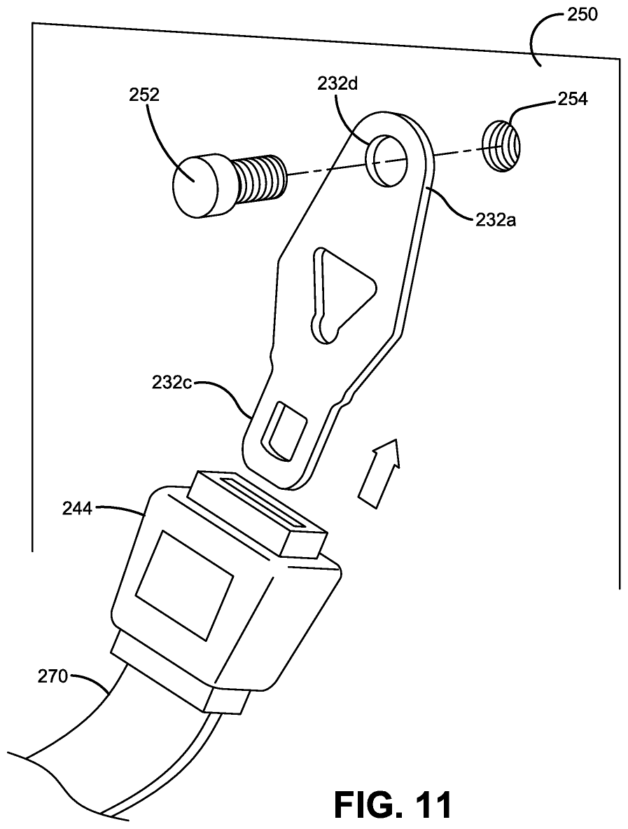

As shown in FIG. 11, the shoulder belt adapter bracket 232 is attached to a vehicle wall 250 using a securing bolt 252 that passes through the hole 232d formed in the round end portion 232a of the shoulder belt adapter bracket 232 to engage with a suitable mounting structure behind an opening 254 in the vehicle wall 250, as is commonly understood by those having skill in the art. In this manner, the shoulder belt adapter bracket 232 is securely mounted to the vehicle wall 250 so that the clip end 232c can engage the belt buckle 244 attached to a seat belt 270 in an operative connection, and is thus capable of restraining a user wearing the seat belt 270.

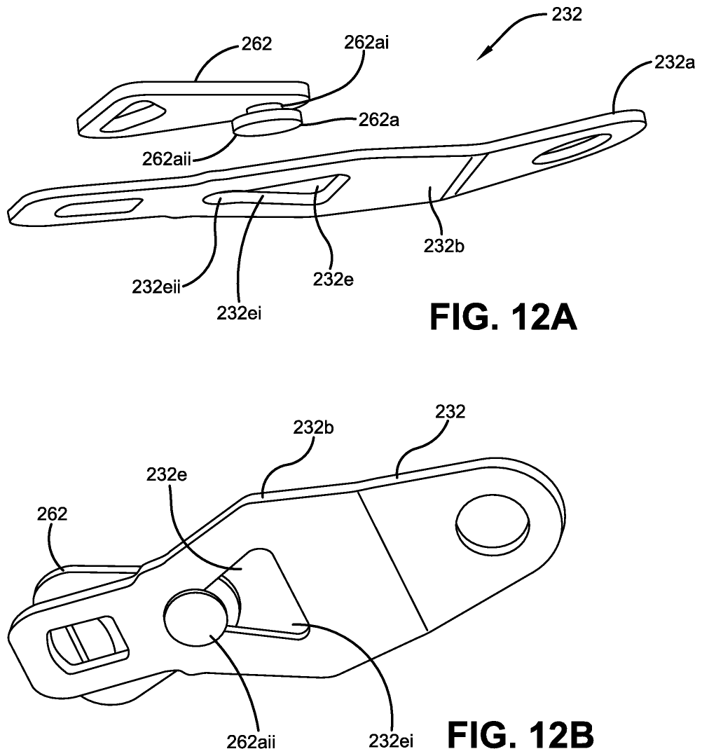

As shown in FIGS. 12A and 12B, the shoulder belt adapter bracket 232 is implemented in a second operative state to engage with a pin connector 262 of a WC/19 lap belt. The keyhole aperture 232e is in the tapered portion 232e of the shoulder belt adapter bracket 232 receives the pin 262a of the pin connector 262 of the lap belt. The pin 262a is inserted into the enlarged triangular portion 232ei of the keyhole aperture 232e and slides down onto the round end 232eii which has diameter comparable to a shank 262ai of the pin 262a, so that the shank 262ai is received in the round end 232eii. The round end 232eii has a diameter smaller than the head 262aii of the pin 262a, so that the head 262aii securely retains the shank 262ai and thereby retains the pin connector 262 in engagement with the keyhole aperture 232a.

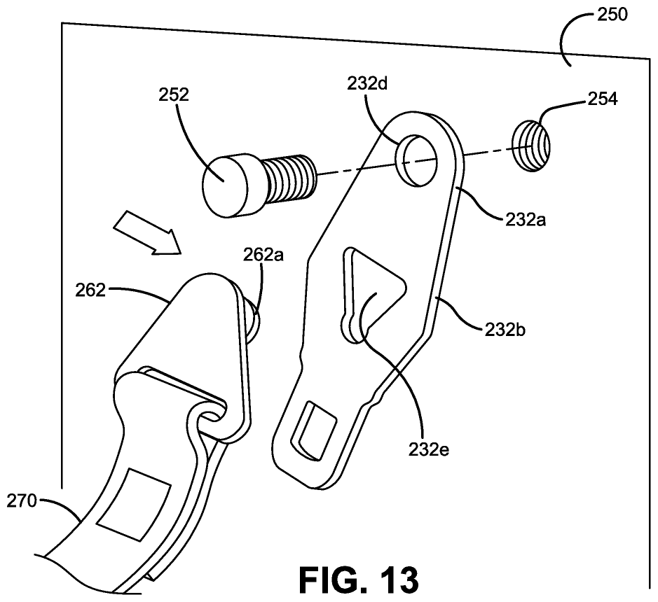

As shown in FIG. 13, as with the implementation of FIG. 11, the shoulder belt adapter bracket 232 is again attached to a vehicle wall 250 using a securing bolt 252 that passes through the hole 232d formed in the round end portion 232a of the shoulder belt adapter bracket 232 to engage with a suitable mounting structure behind an opening 254 in the vehicle wall 250, as is commonly understood by those having skill in the art. In this manner, the shoulder belt adapter bracket 232 is securely mounted to the vehicle wall 250 so that the keyhole aperture 232e can engage the pin connector 262 of a WC/19 lap belt 272 in an operative connection, and is thus capable of restraining a user wearing the belt 272.

Clause 1—A shoulder belt adapter bracket for engaging a seat belt in a vehicle, including a mounting portion having a mounting structure for securing the bracket to a vehicle wall, a first engaging portion having an aperture for receiving a male connecting element of a first type of seat belt for connecting to the first type of seat belt in a first operative state, and a second engaging portion having a male end received for engagement with a female buckle of a second type of seat belt for connecting to the second type of seat belt in a second operative state.

Clause 2—The shoulder belt adapter bracket of clause 1, wherein the mounting portion adjoins the first engaging portion which adjoins the second engaging portion along a central axis.

Clause 3—The shoulder belt adapter bracket of clauses 1 or 2, wherein the mounting portion, the first engaging portion and the second engaging portion are mirror symmetrical about the central axis.

Clause 4—The shoulder belt adapter bracket of clauses 1-3, wherein the mounting portion is a generally round end portion and the mounting structure comprises a hole for receiving a securing bolt for mounting to a vehicle wall.

Clause 5—The shoulder belt adapter bracket of clauses 1-4, wherein the first engaging portion is a tapered portion formed to include a keyhole aperture for receiving and engaging a pin connector of the first type of seat belt in the first operative state.

Clause 6—The adaptable vehicle seat belt of clauses 1-5, wherein the keyhole aperture comprises a triangular portion that terminates with a round end, wherein the triangular portion is sized to admit and receive the pin connector such that the pin connector is slid into secure engagement with the round end.

Clause 7—The adaptable vehicle seat belt of clauses 1-6, wherein the pin connector comprises a pin having a head and a shank such that the round end has a diameter comparable to the shank so that the shank is received in the round end, and wherein the diameter of the round end is smaller than the head so that the head securely retains the shank in engagement with the keyhole aperture.

Clause 8—The shoulder belt adapter bracket of clauses 1-7, wherein the second engaging portion is a generally square male clip end received for secure engagement within the female buckle of the second type of seat belt.

Clause 9—The shoulder belt adapter bracket of clauses 1-8, wherein the clip end includes an aperture that is configured to engage a suitable mating structure inside the female buckle in order to securely retain the clip end within the female buckle until selectively released by a user.

Clause 10—The shoulder belt adapter bracket of clauses 1-9, wherein the first type of seat belt is a conventional seat belt and the second type of seat belt is a WC/19 lap belt.

Clause 11—The shoulder belt adapter bracket of clauses 1-10, wherein the round end and the male clip end are angled with respect to a tapered portion at an angle of between approximately −45 degrees to 45 degrees.

Clause 12—The shoulder belt adapter bracket of clauses 1-11, wherein the round end and the male clip end are angled with respect to a tapered portion at an angle of between approximately −5 degrees to 5 degrees.

Clause 13—A shoulder belt adapter bracket for engaging a seat belt in a vehicle, including an end portion comprising a hole for receiving a securing bolt for mounting to a vehicle wall, a tapered portion, substantially adjoining the end portion along a central axis, formed to include a keyhole aperture for receiving and engaging a pin connector of a WC/19 lap belt in a first operative state, and a generally square male clip end, substantially adjoining the tapered portion along the central axis, and received for secure engagement within a female buckle of a conventional seat belt in a second operative state, wherein the end portion, the tapered portion and the clip end are mirror symmetrical about the central axis.

Clause 14—The adaptable vehicle seat belt of clause 13, wherein the keyhole aperture comprises a triangular portion that terminates with a round end, wherein the triangular portion is sized to admit and receive the pin connector such that the pin connector is slid into secure engagement with the round end.

Clause 15—The adaptable vehicle seat belt of clauses 13 or 14, wherein the pin connector comprises a pin having a head and a shank such that the shank and the round end have comparable diameters so that the shank is received in the round end, and wherein the diameter of the round end is smaller than the head so that the head securely retains the shank in engagement with the keyhole aperture.

Clause 16—The shoulder belt adapter bracket of clauses 13-15, wherein the clip end includes an aperture that is configured to engage a suitable mating structure inside the female buckle in order to securely retain the clip end within the female buckle until selectively released by a user.

Clause 17—A shoulder belt adapter bracket for engaging a seat belt in a vehicle, including an end portion comprising a hole for receiving a securing bolt for mounting to a vehicle wall, a tapered portion, substantially adjoining the end portion along a central axis, formed to include a keyhole aperture for receiving and engaging a pin connector of a WC/19 lap belt in a first operative state, wherein the keyhole aperture comprises a triangular portion that terminates with a round end, wherein the triangular portion is sized to admit and receive a pin of the pin connector, wherein the pin comprises a head and a shank such that the shank and the round end have comparable diameters so that the shank is received in the round end, and wherein the diameter of the round end is smaller than the head so that the head securely retains the shank in engagement with the keyhole aperture, so that the pin connector is slid into secure engagement with the round end, and a generally square male clip end, substantially adjoining the tapered portion along the central axis, and received for secure engagement within a female buckle of a conventional seat belt in a second operative state, wherein the clip end includes an aperture that is configured to engage a suitable mating structure inside the female buckle in order to securely retain the clip end within the female buckle until selectively released by a user, wherein the end portion, the tapered portion and the clip end are mirror symmetrical about the central axis.

Clause 18—The shoulder belt adapter bracket of clause 17, wherein the round end and the male clip end are angled with respect to a tapered portion at an angle of between approximately −45 degrees to 45 degrees.

Clause 19—The shoulder belt adapter bracket of clauses 17 or 18, wherein the round end and the male clip end are angled with respect to a tapered portion at an angle of between approximately −5 degrees to 5 degrees.

As disclosed, the present system provides an adaptable safety belt design that provides safe restraint for multiple different types of wheelchairs. The present safety belt system thereby provides a single economical solution that provides safe vehicle transport for all wheelchair occupants.

Numerous aspects have been described herein. It will be apparent to those skilled in the art that the above methods and apparatuses may incorporate changes and modifications without departing from the general scope the present teachings. It is intended to include all such modifications and alterations in so far as they come within the scope of the appended claims or the equivalents thereof.

Having thus described the present teachings, it is now claimed:

What is claimed:

1. A shoulder belt adapter bracket for engaging a seat belt in a vehicle, comprising:
a mounting portion having a mounting structure for securing the bracket to a vehicle wall;
a first engaging portion having an aperture for receiving a male connecting element of a first type of seat belt for connecting to the first type of seat belt in a first operative state; and
a second engaging portion having a male end received for engagement with a female buckle of a second type of seat belt for connecting to the second type of seat belt in a second operative state.

2. The shoulder belt adapter bracket of claim 1, wherein the mounting portion adjoins the first engaging portion which adjoins the second engaging portion along a central axis.

3. The shoulder belt adapter bracket of claim 2, wherein the mounting portion, the first engaging portion and the second engaging portion are mirror symmetrical about the central axis.

4. The shoulder belt adapter bracket of claim 2, wherein the mounting portion is a generally round end portion and the mounting structure comprises a hole for receiving a securing bolt for mounting to a vehicle wall.

5. The shoulder belt adapter bracket of claim 2, wherein the first engaging portion is a tapered portion formed to include a keyhole aperture for receiving and engaging a pin connector of the first type of seat belt in the first operative state.

6. The adaptable vehicle seat belt of claim 5, wherein the keyhole aperture comprises a triangular portion that terminates with a round end, wherein the triangular portion is sized to admit and receive the pin connector such that the pin connector is slid into secure engagement with the round end.

7. The adaptable vehicle seat belt of claim 6, wherein the pin connector comprises a pin having a head and a shank such that the round end has a diameter comparable to the shank so that the shank is received in the round end, and wherein the diameter of the round end is smaller than the head so that the head securely retains the shank in engagement with the keyhole aperture.

8. The shoulder belt adapter bracket of claim 2, wherein the second engaging portion is a generally square male clip end received for secure engagement within the female buckle of the second type of seat belt.

9. The shoulder belt adapter bracket of claim 7, wherein the clip end includes an aperture that is configured to engage a suitable mating structure inside the female buckle in order to securely retain the clip end within the female buckle until selectively released by a user.

10. The shoulder belt adapter bracket of claim 1, wherein the first type of seat belt is a conventional seat belt and the second type of seat belt is a WC/19 lap belt.

11. The shoulder belt adapter bracket of claim 8, wherein the round end and the male clip end are angled with respect to a tapered portion at an angle of between approximately −45 degrees to 45 degrees.

12. The shoulder belt adapter bracket of claim 11, wherein the round end and the male clip end are angled with respect to a tapered portion at an angle of between approximately −5 degrees to 5 degrees.

13. A shoulder belt adapter bracket for engaging a seat belt in a vehicle, comprising:
an end portion comprising a hole for receiving a securing bolt for mounting to a vehicle wall;
a tapered portion, substantially adjoining the end portion along a central axis, formed to include a keyhole aperture for receiving and engaging a pin connector of a WC/19 lap belt in a first operative state; and
a generally square male clip end, substantially adjoining the tapered portion along the central axis, and received for secure engagement within a female buckle of a conventional seat belt in a second operative state,
wherein the end portion, the tapered portion and the clip end are mirror symmetrical about the central axis.

14. The adaptable vehicle seat belt of claim 13, wherein the keyhole aperture comprises a triangular portion that terminates with a round end, wherein the triangular portion is sized to admit and receive the pin connector such that the pin connector is slid into secure engagement with the round end.

15. The adaptable vehicle seat belt of claim 14, wherein the pin connector comprises a pin having a head and a shank such that the shank and the round end have comparable diameters so that the shank is received in the round end, and wherein the diameter of the round end is smaller than the head so that the head securely retains the shank in engagement with the keyhole aperture.

16. The shoulder belt adapter bracket of claim 15, wherein the clip end includes an aperture that is configured to engage a suitable mating structure inside the female buckle in order to securely retain the clip end within the female buckle until selectively released by a user.

17. A shoulder belt adapter bracket for engaging a seat belt in a vehicle, comprising:
an end portion comprising a hole for receiving a securing bolt for mounting to a vehicle wall;
a tapered portion, substantially adjoining the end portion along a central axis, formed to include a keyhole aperture for receiving and engaging a pin connector of a WC/19 lap belt in a first operative state, wherein
the keyhole aperture comprises a triangular portion that terminates with a round end, wherein the triangular portion is sized to admit and receive a pin of the pin connector, wherein the pin comprises a head and a shank such that the shank and the round end have comparable diameters so that the shank is received in the round end, and wherein the diameter of the round end is smaller than the head so that the head securely retains the shank in engagement with the keyhole aperture, so that the pin connector is slid into secure engagement with the round end; and
a generally square male clip end, substantially adjoining the tapered portion along the central axis, and received for secure engagement within a female buckle of a conventional seat belt in a second operative state,
wherein the clip end includes an aperture that is configured to engage a suitable mating structure inside the female buckle in order to securely retain the clip end within the female buckle until selectively released by a user,
wherein the end portion, the tapered portion and the clip end are mirror symmetrical about the central axis.

18. The shoulder belt adapter bracket of claim 17, wherein the round end and the male clip end are angled with respect to a tapered portion at an angle of between approximately −45 degrees to 45 degrees.

19. The shoulder belt adapter bracket of claim 18, wherein the round end and the male clip end are angled with respect to a tapered portion at an angle of between approximately −5 degrees to 5 degrees.
